(19) United States
(12) Patent Application Publication
(10) Pub. No.: US 2018/0003103 A1
(43) Pub. Date: Jan. 4, 2018

(54) WASTEGATE ACTUATOR AND WASTEGATE VALVE DRIVING DEVICE

(71) Applicant: Mitsubishi Electric Corporation, Tokyo (JP)

(72) Inventors: Satoshi KAWAMURA, Tokyo (JP); Kenta HATANO, Tokyo (JP)

(73) Assignee: Mitsubishi Electric Corporation, Tokyo (JP)

(21) Appl. No.: 15/542,019

(22) PCT Filed: Apr. 6, 2015
(86) PCT No.: PCT/JP2015/060741

§ 371 Date: Jul. 6, 2017

(51) Int. Cl. F02B 37/18; F16K 1/16; H02P 6/28; F16K 31/04; F16K 37/00; F16K 31/50

(52) U.S. Cl. CPC F02B 37/186; F16K 37/0041; F16K 31/508; H02P 6/28; F16K 31/042; F16K 1/16; F16K 31/043

(57) ABSTRACT

A wastegate actuator includes a direct-current motor, a shaft for opening and closing a wastegate valve of a turbocharger, and a screw mechanism for converting a rotary motion of the direct-current motor into a linear motion of the shaft, and the screw mechanism has a lead angle in accordance with a current of the direct-current motor that is required to hold the shaft at a position.

### TECHNICAL FIELD

The present invention relates to a WG actuator and a WG valve driving device that open and close a wastegate (hereinafter referred to as a WG) valve of a turbocharger mounted in a vehicle.

### BACKGROUND ART

A turbocharger is configured so as to rotate a turbine by using an exhaust gas from an engine, drive a compressor connected with this turbine on the same axis, compress intake air, and supply this compressed intake air to the engine. A WG valve for bypassing the exhaust gas from an exhaust passage to a bypass passage is mounted before the turbine in the exhaust passage. By causing the WG actuator to open or close the WG valve to adjust the inflow of the exhaust gas from the exhaust passage to the bypass passage, the number of rotations of the turbine is controlled (for example, refer to Patent Literature 1).

### CITATION LIST

### Patent Literature

Patent Literature 1: WO 2012/137345

### SUMMARY OF INVENTION

### Technical Problem

A conventional WG actuator adjusts the inflow of an exhaust gas to a bypass passage by transferring the torque of a direct-current motor to a WG valve via a spur gear, to adjust the degree of opening of the WG valve. Because the pressure of the exhaust gas flowing through an exhaust passage is applied in the valve opening direction of the WG valve, it is necessary to cause a current to pass through the direct-current motor at all times in order to maintain the degree of opening of the WG valve. A problem is that because the pressure of the exhaust gas applied to the WG valve becomes the largest when the WG valve is fully closed, it is also necessary to increase the current passing through the direct-current motor, and therefore an excessive current is needed.

The present invention is made in order to solve the above-mentioned problem, and it is an object of the present invention to decrease a current of the direct-current motor, the current being required to hold a shaft at a position in a WG actuator.

### Solution to Problem

According to the present invention, there is provided a WG actuator including: a direct-current motor; a shaft for opening and closing a WG valve of a turbocharger; and a screw mechanism for converting a rotary motion of the direct-current motor into a linear motion of the shaft, in which the screw mechanism has a lead angle in accordance with a current of the direct-current motor, the current being required to hold the shaft at a position.

### Advantageous Effects of Invention

According to the present invention, the torque of the direct-current motor is transferred to the WG valve via the screw mechanism, so that the current of the direct-current motor can be decreased by using a frictional force occurring in the screw mechanism to hold the shaft at a position. Further, by causing the screw mechanism to have a lead angle that depends on a current of the direct-current motor, the current being required to hold the shaft at a position, the current passing through the direct-current motor can be adjusted at a time of designing the WG actuator. A WG actuator in which a small lead angle is used can reduce the current of the direct-current motor that is required to hold the shaft at a position, in comparison with another WG actuator in which a large lead angle is used.

### BRIEF DESCRIPTION OF DRAWINGS

FIG. 1 is a cross-sectional view showing an example of the configuration of a WG actuator according to Embodiment 1 of the present invention;

FIG. 2 is an enlarged cross-sectional view of a screw mechanism of the WG actuator according to Embodiment 1;

FIG. 3 is a diagram explaining the lead angle of the screw mechanism of the WG actuator according to Embodiment 1; and

FIGS. 4A and 4B are diagrams explaining the lead of the screw mechanism of the WG actuator according to Embodiment 1, and FIG. 4A shows an example in which a male screw portion is formed so as to have a short lead and FIG. 4B shows an example in which the male screw portion is formed so as to have a long lead.

### DESCRIPTION OF EMBODIMENTS

Hereafter, in order to explain this invention in greater detail, an embodiment of the present invention will be described with reference to the accompanying drawings. Embodiment 1.

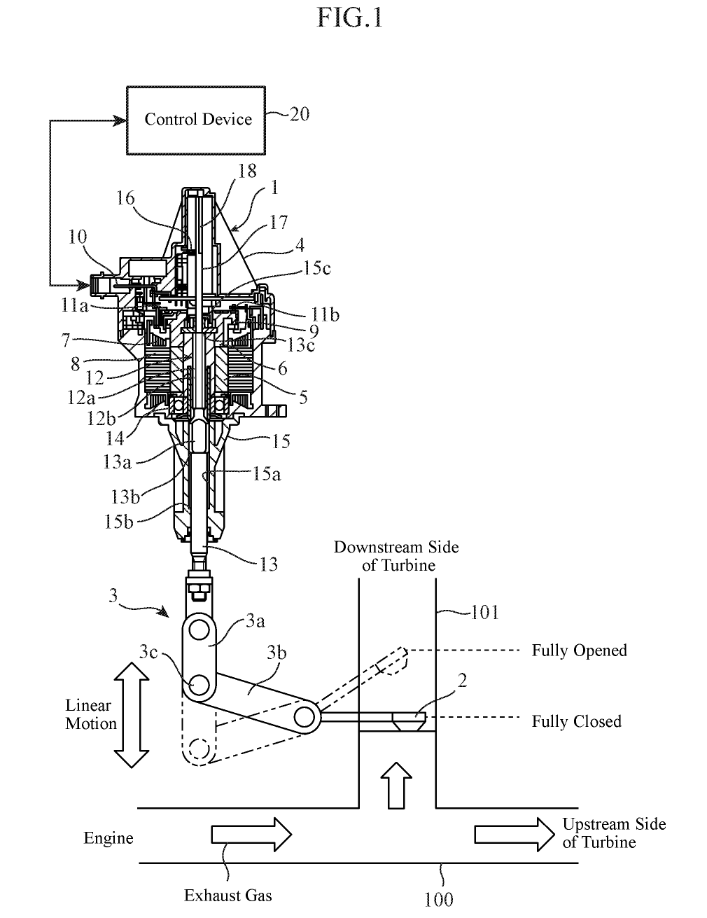

FIG. 1 is a cross-sectional view showing an example of the configuration of a WG actuator 1 according to Embodiment 1. A turbocharger is configured so as to rotate a turbine by using an exhaust gas from an engine, drive a compressor connected with this turbine on the same axis, compress intake air, and supply this compressed intake air to the engine. A WG valve 2 for bypassing the exhaust gas from an exhaust passage 100 to a bypass passage 101 is disposed on an upstream side of the exhaust passage 100 with respect to the turbine. The number of rotations of the turbine is controlled by opening or closing the WG valve 2 to adjust the inflow of the exhaust gas from the exhaust passage 100 to the bypass passage 101 by means of the WG actuator 1. In FIG. 1, a solid line shows a fully closed state of the WG valve 2, and a chain double-dashed line shows a fully opened state of the WG valve 2.

The WG actuator 1 includes a direct-current motor 4 that serves as a driving source, a shaft 13 that opens and closes the WG valve 2, and a screw mechanism 12 that converts a rotary motion of the direct-current motor 4 into a linear motion of the shaft 13. The direct-current motor 4 includes a rotor 6 having a magnet 5 magnetized into a plurality of N and S poles, and a stator 8 on which coils 7 are wound. Brushes 11b are connected with ends of the coils 7. The rotor 6 is rotatably supported by a bearing portion 14 on one end side thereof, and a commutator 9 is fixed on the other end side of the rotor 6.

When a voltage is applied to an external terminal 10, currents flow through commutator bars in contact with brushes 11a, among plural commutator bars which configure the commutator 9, via the brushes 11a connected with this external terminal 10, and currents flow through the coils 7 via the brushes 11b electrically connected with these commutator bars. The stator 8 is magnetized into an N pole and an S pole by the passage of the currents through the coils 7, and the N pole and the S pole of the stator 8 repel and attract the N pole and the S pole of the magnet 5 and this causes the rotor 6 to rotate. As the rotor 6 rotates, the coils 7 through which the currents are made to pass are switched and, as a result, the poles of the stator 8 are also switched and the rotor 6 continues rotating. When the directions of the currents are reversed, the direction of rotation of the rotor 6 is also reversed.

Although a DC motor with brushes is used as the direct-current motor 4 in FIG. 1, a brushless DC motor may be used.

A hole used for disposing the shaft 13 therein is made inside the rotor 6, and a female screw portion 12a is formed on an inner circumferential surface of the hole and a male screw portion 12b is formed on an outer circumferential surface of the shaft 13. This male screw portion 12b is screwed into and coupled with the female screw portion 12a, and a rotary motion of the rotor 6 is converted into a linear motion of the shaft 13. The screw mechanism 12 consists of these female screw portion 12a and male screw portion 12b. One end of the shaft 13 penetrates the housing 15, and is joined to the WG valve 2 via a linkage mechanism 3. A position sensor 16 for detecting the position of this shaft 13 in an axial direction, and so on are disposed on the other end side of the shaft 13.

The linkage mechanism 3 has two plates 3a and 3b. The shaft 13 is attached to one end of the plate 3a, and one end of the plate 3b is attached rotatably to a supporting point 3c disposed on the other end side of the plate 3a. The WG valve 2 is attached to the other end side of this plate 3b. When the shaft 13 moves in a direction in which the shaft is pushed out from the housing 15 in response to a rotation in a direction of the rotor 6, the plate 3a also moves in the same direction, the plate 3b and the WG valve 2 rotate around the supporting point 3c, and the WG valve 2 moves in a valve opening direction. When the shaft 13 moves in a direction in which the shaft is retracted into the housing 15 in response to a rotation in a reverse direction of the rotor 6, the plate 3a also moves in the same direction, and the plate 3b and the WG valve 2 rotate around the supporting point 3c, and the WG valve 2 moves in a valve closing direction.

Two flat surfaces or the likes are formed on the shaft 13, and function as a rotation limiting portion 13a. Further, on an inner circumferential surface of a hole of the housing 15 which the shaft 13 penetrates, a guide portion 15a, such as two flat surfaces, is formed in such a way as to have a shape matching the shape of the rotation limiting portion 13a. Sliding between the rotation limiting portion 13a and the guide portion 15a prevents the shaft 13 from rotating in synchronization with a rotation of the rotor 6, to support the shaft 13 in such a way as to cause the shaft to make a linear motion. A stopper 15b projecting toward the shaft 13 is formed at an end of the guide portion 15a. By causing a butting portion 13b which is shaped so as to project from the shaft 13 to come into contact with this stopper 15b, the shaft 13 is prevented from further making a linear motion in the valve opening direction. Similarly, a plate that functions as a stopper 15c is disposed at an end of the screw mechanism 12. By causing an end surface of the shaft 13 that functions as a butting portion 13c to come into contact with the stopper 15c, the shaft 13 is prevented from further moving in the valve closing direction.

In the plate that functions as the stopper 15c for the shaft 13, a hole having a diameter smaller than the outer diameter of the shaft 13 penetrates, and a shaft for sensor 17 is made to pass through this hole, and an end surface of the shaft for sensor 17 is in contact with the end surface of the shaft 13. As a result, the shaft for sensor 17 also reciprocates in synchronization with a reciprocating motion in the axial direction of the shaft 13. A magnet for sensor 18 is fixed to this shaft for sensor 17, and, when the position of the magnet for sensor 18 with respect to the position sensor 16 changes due to the reciprocating motion of the shaft 13, a flux density passing through the position sensor 16 also changes. The position sensor 16 is a Hall element or a magnetoresistive element, and detects the flux density which changes due to a reciprocating motion of the shaft 13 and converts the flux density into an electric signal showing an actual stroke position of the shaft 13 and outputs the electric signal to a control device 20.

The control device 20 receives the electric signal showing the actual stroke position of the shaft 13 from the position sensor 16. The control device 20 also receives a target stroke position of the shaft 13 from a not-shown engine control unit or the like. The control device 20 then performs feedback control in such a way that the actual stroke position gets close to the target stroke position, to adjust the current passing through the direct-current motor 4, and generates a torque proportional to the passing current, to move the shaft 13 and hold the shaft at a position. Hereafter, the torque and the passing current required to hold the shaft 13 at a position are referred to as the holding torque and the holding current.

The control device 20 is implemented by a processing circuit, such as a CPU or a system LSI, which executes a program stored in a memory. In the illustrated example, the control device 20 is configured as an independent electronic control unit, but the control device can be configured so as to be implemented as one function of the not-shown engine control unit, or can be incorporated, as a circuit board, in the interior of the WG actuator 1.

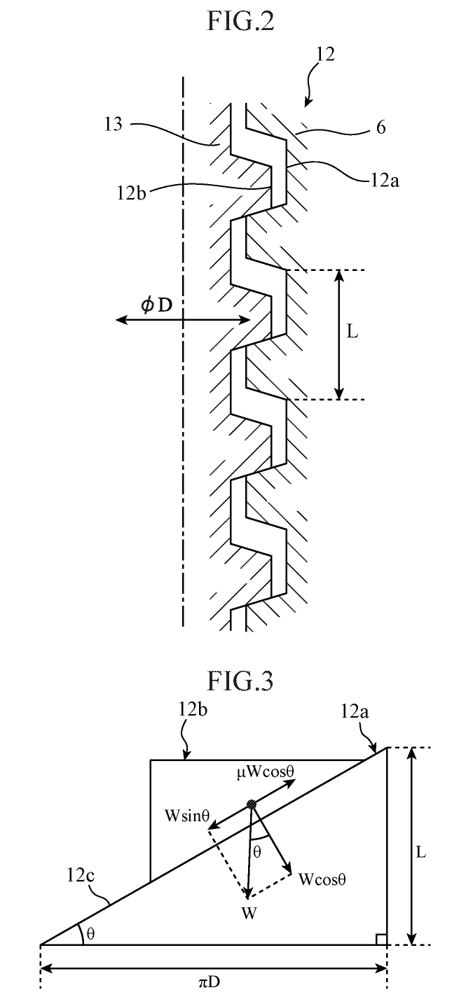

FIG. 2 is an enlarged diagram of the screw mechanism 12 of the WG actuator 1, and shows a cross section of the female screw portion 12a and the male screw portion 12b. D denotes the effective diameter of the female screw portion 12a and the male screw portion 12b. L denotes the lead of the female screw portion 12a and the male screw portion 12b, and is the distance which the male screw portion 12b of the shaft 13 travels in the axial direction while the female screw portion 12a of the rotor 6 makes one rotation.

FIG. 3 is a diagram explaining the lead angle θ of the screw mechanism 12. If a right angled triangle illustrated is wound around a hollow cylinder, a sloped surface 12c of the right angled triangle has a spiral shape extending along a screw thread. The lead angle θ is the angle of inclination of the sloped surface 12c. That is, the lead angle is the angle which is formed with respect to the radial direction of the screw thread having a spiral shape. When a load W in an axial direction is applied to the female screw portion 12a, a force of W cos θ is applied perpendicularly to the sloped surface 12c. The male screw portion 12b is going to slide in a direction downward along the sloped surface 12c because of a force of W sin θ, and a frictional force of μW cos θ occurs in a direction upward along the sloped surface 12c. μ denotes the coefficient of friction of the sloped surface 12c. When the lead angle θ is increased, and the sliding force of W sin θ becomes larger than the frictional force of μW cos θ, the male screw portion 12b slides and the shaft 13 rotates. In general, when the frictional force of μW cos θ and the sliding force of W sin θ are evenly balanced, μ becomes equal to tan θ, and this θ is referred to as the friction angle.

Because an exhaust gas pressure (hereinafter referred to as a “valve opening force”) in the valve opening direction is applied to the WG valve 2, the load W is applied also to the shaft 13 joined to this WG valve 2 in the valve opening direction. However, the frictional force of μW cos θ is applied between the male screw portion 12b of the shaft 13 and the female screw portion 12a of the rotor 6, which prevents the shaft 13 from easily rotating. More specifically, the provision of the screw mechanism 12 makes it possible to decrease the valve opening force of the exhaust gas which is applied to the shaft 13.

Because a force for holding the shaft 13 at a position against the valve opening force of the exhaust gas is substantially equal to the sum of the frictional force occurring in the screw mechanism 12 and the holding torque of the direct-current motor 4, when the frictional force occurring in the screw mechanism 12 increases, the holding torque of the direct-current motor 4 can be decreased in proportion to the increase in the frictional force, and therefore the holding current can be decreased. Therefore, the configuration of transferring the torque of the direct-current motor 4 to the WG valve 2 via the screw mechanism 12, as shown in Embodiment 1, can make the current passing through the direct-current motor lower than that in a conventional configuration of transferring the torque of the direct-current motor 4 to the WG valve 2 via a spur gear.

Further, when the lead angle θ of the screw mechanism 12 is decreased, the frictional force of μW cos θ increases, so that the holding torque required to hold the shaft 13 at a position against the load W is reduced, and the holding current can also be decreased. In contrast, when the lead angle θ is increased, the frictional force of μW cos θ decreases, and a greater holding torque is needed, and the holding current also increases.

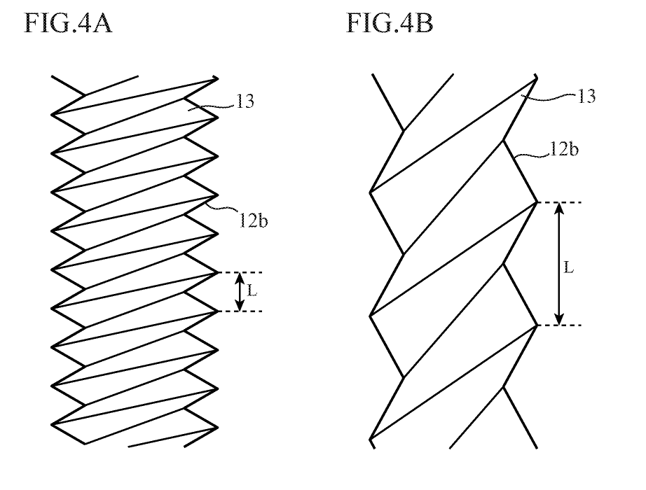

FIGS. 4A and 4B are diagrams explaining the lead L of the screw mechanism 12, and FIG. 4A shows an example in which the male screw portion 12b is formed so as to have a small lead angle θ, i.e., a short lead L and FIG. 4B shows an example in which the male screw portion 12b is formed so as to have a large lead angle θ, i.e., a long lead L. Although the male screw portion 12b is shown in FIGS. 4A and 4B, the female screw portion 12a is also formed in the same way. Because the lead L of the male screw portion 12b having a small lead angle θ is short, the speed at which the shaft 13 makes a linear motion becomes lower than the speed at which the rotor 6 rotates, and the responsivity is degraded. In contrast, because the lead L of the male screw portion 12b having a large lead angle θ is long, the speed at which the shaft 13 makes a linear motion becomes higher than the speed at which the rotor 6 rotates, and the responsivity is improved.

As mentioned above, when the lead angle of the screw mechanism 12 is decreased, the holding current of the direct-current motor 4 decreases, and the responsivity is degraded. In contrast, when the lead angle of the screw mechanism 12 is increased, the holding current passing through the direct-current motor 4 increases, and the responsivity is improved. On the basis of the above-mentioned characteristics, the lead angle of the screw mechanism 12 is determined at a time of designing the WG actuator 1 in such a way that a desired holding current and a desired degree of responsivity are satisfied. Because the pressure of the exhaust gas flowing through the exhaust passage 100 varies with time, and the exhaust gas pressure applied to the WG valve 2 differs dependently on the degree of opening of the WG valve 2, it is preferable to, for example, select a lead angle in accordance with the average value of the holding current, or a lead angle in accordance with the maximum value of the holding current.

In addition, it is desirable to make the lead angle of the male screw portion 12b smaller than the friction angle in order to prevent sliding from occurring between the female screw portion 12a and the male screw portion 12b. Concretely, the lead angle θ is selected in such a way that the coefficient of friction μ of the sloped surface 12c of the screw mechanism 12 and the lead angle θ have the following relationship: μ>tan θ in FIG. 3. As a result, even if the load W is applied, the frictional force of μW cos θ is larger than the sliding force of W sin θ, and therefore the shaft 13 does not rotate, and the holding current can be reduced to zero.

Although the example of decreasing the holding current of the direct-current motor 4 by decreasing the lead angle of the screw mechanism 12 is explained above, an example of decreasing the holding current by changing a control method which the control device 20 uses in addition to changing the lead angle will be explained below.

In this example, the WG actuator 1 shown in FIG. 1 is configured in such a way that, when the shaft 13 retracted into the housing 15 until the WG valve 2 reaches its fully closed position, the stopper 15c and the butting portion 13c come into contact with each other, thereby limiting the movement of the shaft 13. In this configuration, when determining that the WG actuator has retracted the shaft 13 until the WG valve 2 reaches the fully closed position, on the basis of the actual stroke position of the shaft 13 detected by the position sensor 16, the control device 20 retightens the screw mechanism 12 by maintaining the current passing through the direct-current motor 4 until a predetermined time has elapsed after the time of the determination, to rotate the rotor 6 in a state in which the butting portion 13c of the shaft 13 is in contact with the stopper 15c. As a result, the frictional force between the female screw portion 12a and the male screw portion 12b increases, and even if the load W is applied, it is difficult for the shaft 13 to rotate. Therefore, after the above-mentioned predetermined time has elapsed, the holding current at a time of holding the shaft 13 at a position corresponding to the fully closed position of the WG valve 2 can be decreased. It is assumed that the above-mentioned predetermined time is stored in advance in a memory in the control device 20.

Although the WG actuator 1 shown in FIG. 1 is configured so as to retract the shaft 13 to close the WG valve 2, in a case in which, in contrast to this configuration, the WG actuator is configured so as to push out the shaft 13 to close the WG valve 2, when determining that the WG actuator has pushed out the shaft 13 until the WG valve 2 reaches the fully closed position, the control device 20 retightens the screw mechanism by maintaining the current passing through the direct-current motor 4 during a predetermined time, to rotate the rotor 6 in a state in which the butting portion 13b of the shaft 13 is in contact with the stopper 15b.

As mentioned above, because the WG actuator 1 according to Embodiment 1 is configured so as to include the direct-current motor 4, the shaft 13 for opening and closing the WG valve 2 of the turbocharger, and the screw mechanism 12 for converting a rotary motion of the direct-current motor 4 into a linear motion of the shaft 13, the WG actuator can decrease the holding current passing through the direct-current motor 4 by using the frictional force occurring in the screw mechanism 12 to hold the shaft 13 at a position. Further, by causing the screw mechanism 12 to have a lead angle in accordance with the holding current of the direct-current motor 4 that is required to hold the shaft 13 at a position, the holding current passing through the direct-current motor 4 can be adjusted at a time of designing the WG actuator 1. The WG actuator 1 in which a small lead angle is used can reduce the holding current required to hold the shaft 13 at a position, in comparison with the WG actuator 1 in which a large lead angle is used.

Further, according to Embodiment 1, by making the lead angle of the screw mechanism 12 smaller than the friction angle, even if the pressure of the exhaust gas is applied, the shaft 13 can be prevented from rotating and the holding current passing through the direct-current motor 4 can be made to be zero.

Further, the WG actuator 1 according to Embodiment 1 is configured in such a way that the WG actuator includes the stopper 15c for limiting a linear motion of the shaft 13 at the position where the WG valve 2 is fully closed, and, when the WG valve 2 is fully closed, the control device 20 maintains the current of the direct-current motor 4 that is required for a linear motion of the shaft 13, in a state in which the shaft 13 is limited by the stopper 15c, until a predetermined time has elapsed, and the frictional force of the screw mechanism 12 can be increased when the WG valve 2 is fully closed. As a result, the holding current required to hold the shaft 13 at a position corresponding to the fully closed position of the WG valve 2 can be decreased.

Although in the above-mentioned explanation the configuration of joining the shaft 13 of the WG actuator 1 according to the present invention and the WG valve 2 by using the linkage mechanism 3 is shown, a configuration of directly joining the shaft 13 and the WG valve 2 without using the linkage mechanism 3 can be alternatively provided.

Further, a WG valve driving device including the WG actuator 1 according to the present invention, and the WG valve 2 which is the target to be driven can be configured.

In the present invention, it is to be understood that, in addition to the above-mentioned embodiment, various changes can be made in an arbitrary component according to the embodiment, and an arbitrary component according to the embodiment can be omitted within the scope of the invention.

### INDUSTRIAL APPLICABILITY

Because the WG actuator according to the present invention can decrease the current passing through the direct-current motor, the WG actuator is suitable for use as an actuator or the like which is mounted in a vehicle.

### REFERENCE SIGNS LIST

1 WG actuator, 2 WG valve, 3 linkage mechanism, 3a, 3b plate, 3c supporting point, 4 direct-current motor, 5 magnet, 6 rotor, 7 coil, 8 stator, 9 commutator, 10 external terminal, 11a, 11b brush, 12 screw mechanism, 12a female screw portion, 12b male screw portion, 12c sloped surface, 13 shaft, 13a rotation limiting portion, 13b, 13c butting portion, 14 bearing portion, 15 housing, 15a guide portion, 15b, 15c stopper, 16 position sensor, 17 shaft for sensor, 18 magnet for sensor, 20 control device, 100 exhaust passage, 101 bypass passage, D effective diameter, L lead, W load, and θ lead angle.

1. A wastegate actuator comprising:
a direct-current motor;
a shaft to open and close a wastegate valve of a turbocharger; and
a screw mechanism to convert a rotary motion of the direct-current motor into a linear motion of the shaft,
wherein the screw mechanism has a lead angle in accordance with a current of the direct-current motor, the current being required to hold the shaft at a position.

2. The wastegate actuator according to claim 1, wherein the lead angle of the screw mechanism is smaller than a friction angle.

3. The wastegate actuator according to claim 1, further comprising a position sensor to detect a position of the shaft; and
a control device to adjust a current passing through the direct-current motor on a basis of the position of the shaft detected by the position sensor.

4. The wastegate actuator according to claim 3, further comprising a stopper to limit the linear motion of the shaft at a position where the wastegate valve is fully closed, and
wherein when the wastegate valve is fully closed, the control device maintains a current of the direct-current motor, the current being required for the linear motion of the shaft, in a state in which the shaft is limited by the stopper, until a predetermined time has elapsed.

5. A wastegate valve driving device comprising:
the wastegate actuator according to claim 1; and
a wastegate valve that is driven by the wastegate actuator.
